(19) United States
(12) Patent Application Publication
(10) Pub. No.: US 2007/0005936 A1
(43) Pub. Date: Jan. 4, 2007

(54) More flexible monitoring and recovery of processes on data processing systems

(76) Inventor: Luis Ortega, Baierfeld (DE)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 11/432,175

(22) Filed: May 11, 2006

(30) Foreign Application Priority Data
May 11, 2005 (DE) 10 2005 021 853.9

(51) Int. Cl. G06F 15/00; G06F 15/76

(52) U.S. Cl. 712/1

(57) ABSTRACT

More flexible monitoring and recovery of processes on data processing systems The invention relates to a data processing system with means for administering processes running on the system, with there being provision for collecting together processes into groups, and a method for recovering execution sequences of the data processing system. in accordance with the invention the process administration is designed for establishing dependencies between process groups or individual processes and process groups. In the method the recovery of an execution sequence of a data processing system is undertaken in accordance with the dependencies between process groups or individual processes and process groups. The invention has the advantage of structuring process groups more flexibly.

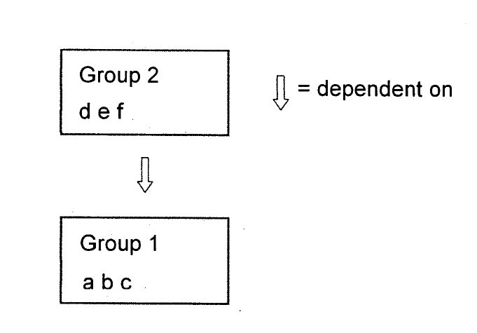

### CROSS REFERENCE TO RELATED APPLICATIONS

This application claims priority of German application No. 102005021853.9 DE filed May 11, 2005, which is incorporated by reference herein in its entirety.

### FIELD OF INVENTION

The invention relates to a data processing system with means for administering processes running on the system, with there being provision for collecting processes into groups, and to a method for recovering execution sequences of a data processing system.

### BACKGROUND OF INVENTION

The requirement exists in data processing systems for a number of tasks to be processed simultaneously. For example a user operates his PC (Personal Computer) to play a computer game while activities or processes are running simultaneously on the computer to receive incoming e-mails and execute other applications, e.g. displaying the time. Since most computers used in the private and business sector only have one processor or CPU, the requirement is for the computer to handle a number of programs simultaneously with one CPU. This requirement also applies to modem data processing systems with a number of processors, since frequently the number of programs or tasks to be handled exceeds the number of processors.

This requirement is met in modem computer systems by the processor or the CPU (Central Processing Unit) changing between different programs in a rapid rhythm (typically in the range of ten or 100 milliseconds) which on the time scale relevant for the user leads to a suggestion of parallel processing of the programs. A pseudo parallelism is thus referred to here by contrast with a true parallelism which identifies processing by different processors. To illustrate the operation of processors in this way, a model has been developed, as a result of which different processes run on one data processing system. The idea in this case is that the processes run simultaneously whereas a CPU is in reality only ever processing one program. The system thus acts as if each process had its own CPU. This process concept is also applied as a rule to multiprocessor systems. The different program execution sequences executed almost in parallel are thus referred to as processes. These processes are usually administered with the aid of the operating system of the corresponding computer system. An example of administration of processes by means of operating system commands is the “fork” command in Unix and the functional sequence “create process” in Windows, provided in Win32, by which a new process is generated.

With system interruptions or system crashes in particular, the fact that the processes executing are frequently not independent of each other can have a role to play in the recovery of the operating state. To take account of this fact, the concept of process groups has been included in modem operating systems. This concept of dividing up processes into groups was first introduced in a variant of Unix (Berkeley Unix) named after Berkeley, its place of origin. Unix uses process groups, in which case a process generated by another process belongs to the same group. By contrast, in early versions of Windows there is no option for grouping together processes. The option of grouping together processes was then provided in Windows 2000. Windows 2000 provides tools for process control which includes the feature “job objects” which allows a number of processes to be collected together into a group and administered as a unit.

### SUMMARY OF INVENTION

An object of the invention is to make possible a more flexible and user-friendly administration of processes on data processing systems.

The object is achieved by the objects of the independent claims.

The invention is based on the observation that a flexibilization and expansion of the structuring options of processes can be obtained by introducing dependencies between groups. Thus it is proposed in accordance with the invention that the process administration be expanded to the extent that there is provision for establishing dependencies between process groups or individual processes and process groups. A special case here is the establishment of dependencies between process groups simultaneously with the establishment of dependencies between individual processes and process groups. The dependencies introduced in accordance with the invention can be stored or recorded in a configuration file or a script in the data processing device.

The invention allows greater flexibility in process administration; There is more freedom for designing groups and thereby introducing a new hierarchy level. This makes process administration more user-friendly and more versatile.

The new dependencies introduced in accordance with the invention can be taken into account in a method for recovering the execution sequences of a data processing system which is also an object of this application. This method makes provision, if one or more of the processes running on the data processing system is interrupted, for example in the event of an abnormal termination or a fault, for a dependency of the process or of the process group comprising the process on other process groups to be determined, and for these dependencies to be taken into account on restart as if processes of dependent groups had been aborted and restarted in accordance with the sequence required by the dependencies.

It is sensible to take account in this way of dependencies relating to all groups of processes and to restart the processes of any dependent groups, with the sequence of the restart being undertaken in accordance with the dependencies produced. For this restart an information source, such as a configuration file or a script for example in which the dependencies are stored, can be evaluated.

### BRIEF DESCRIPTION OF THE DRAWING

The object of the invention is explained in greater detail below within the context of an exemplary embodiment which refers to a FIGURE.

### DETAILED DESCRIPTION OF INVENTION

The FIGURE shows two groups of processes, with group 2 comprising processes D, E, F and group 1 processes A, B, C. Group 1 is in this case dependent on group 2. Within the context of the exemplary embodiment it is assumed that processes A, B, C, D, E and F exist which are dependent on one another. Conventionally these processes can only be collected into one (large) group. The invention allows a better structuring of the processes.

For a more detailed description the following dependencies are assumed. Processes A, B, and C are completely independent and can thus be collected into group 1. Processes D, E and F are dependent on process A and can thus be collected into group 2. Group 2 is thus dependent on group 1 and must be started after group 1 during a restart. This is supported in accordance with the invention, with this dependency of group 2 on group 1 being stored in a configuration file, for example an XML file. If one of the processes of group 1 A, B, C now fails and therefore the processes of group 1 are to be restarted, the configuration file in which the dependencies are stored is evaluated for the restart and it is established in this case that the processes of group 2 are dependent on those of group 1. Thus the processes of group 2 D, E and F are aborted and started after the processes of group 1 on restart. This ensures that no errors occur which might be expected during a simultaneous start of the processes of group 1 and group 2.

The invention is not restricted to this simple embodiment. In particular the inventive introduction of group dependencies would let more complex dependencies between processes be suitably administered.

1-6. (canceled)

7. A data processing system for administering processes running on the system, comprising:
a first process group containing a plurality of processes;
a first process excluded from the plurality of processes; and
a process administration that establishes a dependency between the first process group and the first process.

8. The method according to claim 7, further comprising a configuration file for recording the dependency.

9. The method according to claim 7, further comprising:
a second process group containing the first process,
wherein the dependency is established between the first process group and the second process group.

10. The method according to claim 9, further comprising a configuration file for recording the dependency.

11. The method according to claim 7, wherein a plurality of dependencies are established between the first process group and a plurality of process groups.

12. A method for recovering execution sequences of a data processing system, comprising:
providing a first group containing a plurality of processes;
providing a first process that is different from the plurality of processes;
establishing a dependency between the first group and the first process;
interrupting an execution sequence of the first process;
determining a group that does not contain the interrupted process and for which a dependency exists from the interrupted process;
interrupting the processes of the determined group; and
restarting the interrupted first process and the processes of the determined group,
wherein the sequence of the restart is in accordance with the dependencies established.

13. The method according to claim 12, further comprising recording the dependency in a configuration file.

14. the method according to claim 13, wherein the dependency in the configuration file is evaluated for the restart.

15. The method according to claim 12, wherein a plurality of dependencies are established.

16. A method for recovering execution sequences of a data processing system, comprising:
providing a first group containing a plurality of processes;
providing a second group containing a plurality of processes that are different than the processes of the first group;
establishing a dependency between the first and second groups;
interrupting an execution sequence for a process selected from the first and second group;
determining a group that does not contain the interrupted process and for which a dependency exists from the group containing the interrupted process;
interrupting the processes of the determined group; and
restarting the interrupted processes in the group containing the process having the execution sequence interrupted and the processes of the determined group,
wherein the sequence of the restart is in accordance with the dependencies established.

17. The method according to claim 16, further comprising recording the dependencies in a configuration file.

18. the method according to claim 17, wherein the dependency in the configuration file is evaluated for the restart.
